(19) United States
(12) Patent Application Publication
(10) Pub. No.: US 2003/0025968 A1
(43) Pub. Date: Feb. 6, 2003

(54) OCDM detection device

(75) Inventors: Wolfgang Korber, Stuttgart (DE); Harald Schmuck, Schwieberdingen (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/192,550

(22) Filed: Jul. 11, 2002

(30) Foreign Application Priority Data
Aug. 6, 2001 (EP) 01 440 258.0

(51) Int. Cl. H04J 14/08

(52) U.S. Cl. 359/136; 359/135

(57) ABSTRACT

A special solution is required in closed fiber rings in order to remove OCDM transmission signals from the optical ring after they have passed the corresponding receiving node. This object is achieved by an OCDM detection device containing an OCDM detector for detecting received OCDM signals and an optical component controlled by the OCDM detector for transmission or non-transmission of received OCDM signals in at least one optical line. In a variation the OCDM detector detects special OCDM signals in an individual optical transmission channel and is designed in such a way that the optical component is controlled for transmission of OCDM signals if no special OCDM signals are detected and the optical component is controlled for non-transmission of OCDM signals if special OCDM signals are detected.

### TECHNICAL FIELD

The invention relates to an OCDM detection device, a node and a closed optical ring network.

The invention is based on a priority application EP 01 449 258.0 which is hereby incorporated by reference.

### BACKGROUND OF THE INVENTION

Existing and future optical networks, for example so-called metropolitan optical networks, are or will be implemented, for example as closed fibre rings, in particular for short and medium distances. Instead of TDM or WDM, OCDM provides an advantageous variation allowing an increased number of connections between an increased number of nodes at lower cost; TDM=Time Division Multiplex, WDM=Wavelength Division Multiplex, OCDM=Optical Code Division Multiplex. In contrast to TDM and WDM, OCDM transmission channels use the entire transmission spectrum, i.e. a continuous optical wavelength band, simultaneously. The individual OCDM transmission channels are differentiated from one another by different spectral codes.

For WDM and TDM, for example implemented as optical SONET or SDH rings, there are so-called add/drop functions; SONET=Synchronous Optical Network, SDH=Synchronous Digital Hierarchy. Individual transmission channels on nodes can be removed or added to/from the ring by means of these add/drop functions. This removal and addition of individual transmission channels is more difficult in OCDM as each transmission channel uses the same transmission spectrum simultaneously. Normally, a complete signal containing all transmission channels is supplied to each node by means of an optical splitter. The specific transmission channel is then filtered out by means of a code filter. A plurality of code filters for filtering out different transmission channels may also be available in one node.

After filtering the information transmitted in the filtered-out transmission channel is detected.

A disadvantage which results is that the transmission channel(s) filtered in the node is/are not removed from the ring. They continue to propagate on the optical ring together with the remaining transmission channels. A transmission channel filtered in the node cannot be used to transmit new information until the remaining intensity of the signal in the filtered transmission channel has become negligibly small on the optical ring owing to attenuation.

This is a considerable disadvantage precisely for short and middle distances owing to the low attenuation in the optical ring. A plurality of loops have to take place in the ring for appropriate attenuation.

In contrast to unidirectional tree networks which are also used for OCDM networks and in which signals can be terminated at individual nodes, a special solution is required in closed fibre rings in order to remove OCDM transmission signals from the optical ring after they have passed the corresponding receiving node.

### SUMMARY OF THE INVENTION

This object is achieved by an OCDM detection device containing an OCDM detector for detecting received OCDM signals and an optical component controlled by the OCDM detector for transmission or non-transmission of received OCDM signals in at least one optical line.

Advantageous developments can be inferred from the dependent claims and the description hereinafter.

### BRIEF DESCRIPTION OF THE DRAWINGS

Three embodiments of the invention will be described hereinafter with reference to seven figures, in which:

FIG. 1 is a schematic diagram of an optical ring network,

FIG. 2 is a schematic diagram of a detail of a node according to the invention with an OCDM detection device according to the invention,

FIG. 3 is a schematically illustrated design of an optical component from FIG. 2,

FIG. 4 is a schematic diagram of a further optical ring network,

FIG. 5 is a schematic diagram of a detail of a further node according to the invention,

FIG. 6 is a schematic diagram of a further optical ring network and

FIG. 7 is a schematic diagram of a detail of a further node according to the invention.

### BEST MODE FOR CARRYING OUT THE INVENTION

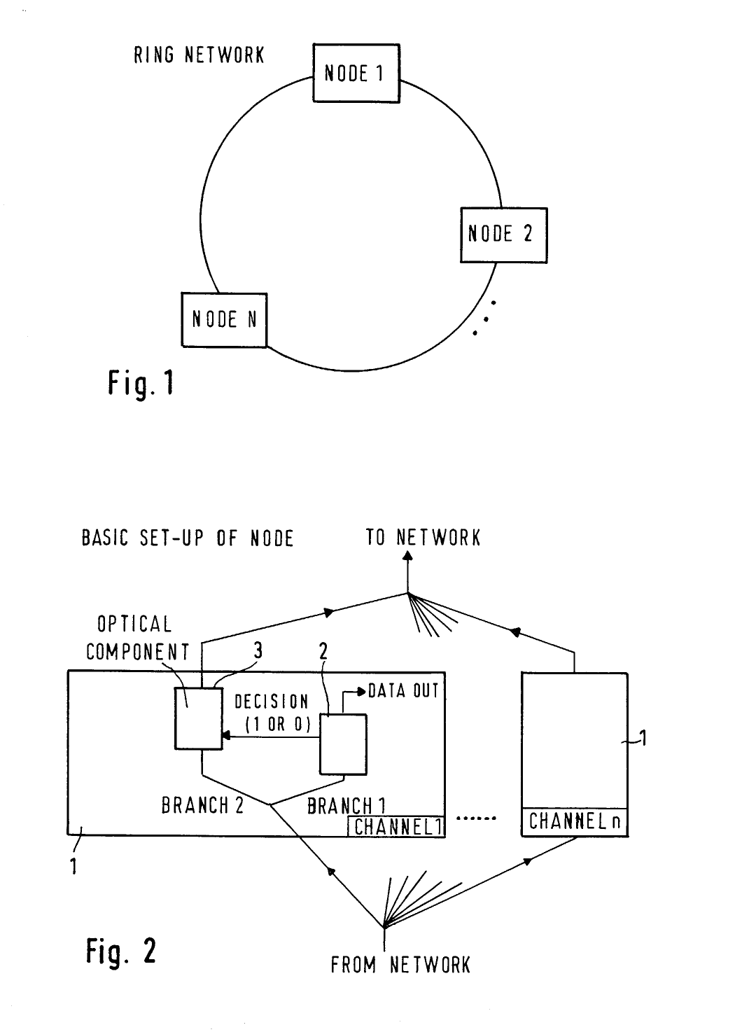

The first embodiment will now be described with the aid of FIG. 1 to 3. FIG. 1 shows an optical ring network. The ring network contains N nodes node 1, node 2, . . . , node N, connected to one another via optical lines; N=a natural integer. The optical lines are formed, for example, by optical glass fibre cables.

The ring network transmits OCDM signals. The OCDM signals are transmitted in a plurality of optical transmission channels. Each node node 1, node 2, . . . , node N can be individually addressed by every other node node 1, node 2, . . . , node N. Each node node 1, node 2, . . . , node N can receive OCDM signals on each optical transmission channel and transmit on each optical transmission channel. Appropriate transmission and receiving units are provided for this purpose. Occupation of individual transmission channels by nodes is managed, for example, by a MAC protocol or a network management; MAC=Medium Access Control.

OCDM signals received in a node node 1, node 2, . . . , node N for which the OCDM signals are intended are extinguished in this node node 1, node 2, . . . , node N by means of destructive interference and are not conveyed further in the ring. For example, OCDM signals are transmitted from node 1 to node 2 in the first optical transmission channel and extinguished in node 2 and not transmitted further on the optical ring to node N. The first transmission channel is then already available again even in node 2 for the transmission of new information. The new information is transmitted, for example in the form of OCDM signals, from node 2 to node N in the first optical transmission channel. Therefore, a so-called add/drop function is achieved for OCDM signal.

The optical glass fibres of the ring do not form an uninterrupted ring to which nodes are connected by means of splitters, but end at components in the nodes node 1, node 2, . . . , node N and begin again at these components. Therefore, components of the nodes node 1, node 2, . . . , node N are inserted, i.e. integrated, into the glass fibre ring.

FIG. 2 shows a detail of the node 1. The nodes node 1, node 2, . . . , node N are identical in design. Node 1 contains an optical splitter serving to divide the glass fibres of the optical ring connected to the nodes node 1 and node N into n glass fibres, n corresponding to the number of optical transmission channels. Each of the n glass fibres is connected to an OCDM detection device 1. Each OCDM detection device 1 is provided for receiving OCDM signals of an optical transmission channel. The output signals of the OCDM detection devices 1 are coupled via n glass fibres and an optical combiner to a glass fibre of the optical ring connected to the nodes node 1 and node 2.

Each OCDM detection device 1 contains an OCDM detector 2 for detecting received OCDM signals and an optical component 3 controlled by the OCDM detector 2 for the transmission or non-transmission of received OCDM signals in at least one optical line connected to the optical combiner. Furthermore, an optical splitter is provided to generate two branches. The received OCDM signals are supplied via the one branch to the OCDM detector 2 and via the other branch to the optical component 3.

The received OCDM signals are checked in the OCDM detector 2 to determine whether they contain certain signals for the node 1. For example, in a header the address of the node 1 is transmitted if OCDM signals for node 1 are determined. OCDM detector 2 filters out, for example via a Mach-Zehnder filter, all received OCDM signals in the first transmission channel. After an optical/electrical conversion the header is evaluated in an electronic circuit containing, for example, a processor, a synchronisation circuit, etc. If the address of the node 1 is present the received OCDM signals of the first transmission channel are transmitted for further data evaluation to a processing device of a receiving unit. In the event of transmission of signals intended for node 1 a control signal is generated controlling the optical component 3 in such a way that the received OCDM signals of the first transmission channel are not transmitted to the network. In the event that no OCDM signals intended for node 1 are detected a control signal is generated controlling the optical component 3 in such a way that the received OCDM signals of the first transmission channel are transmitted.

Simultaneous transmission channel-wise processing is carried out owing to the parallel connection of the OCDM detection devices 1.

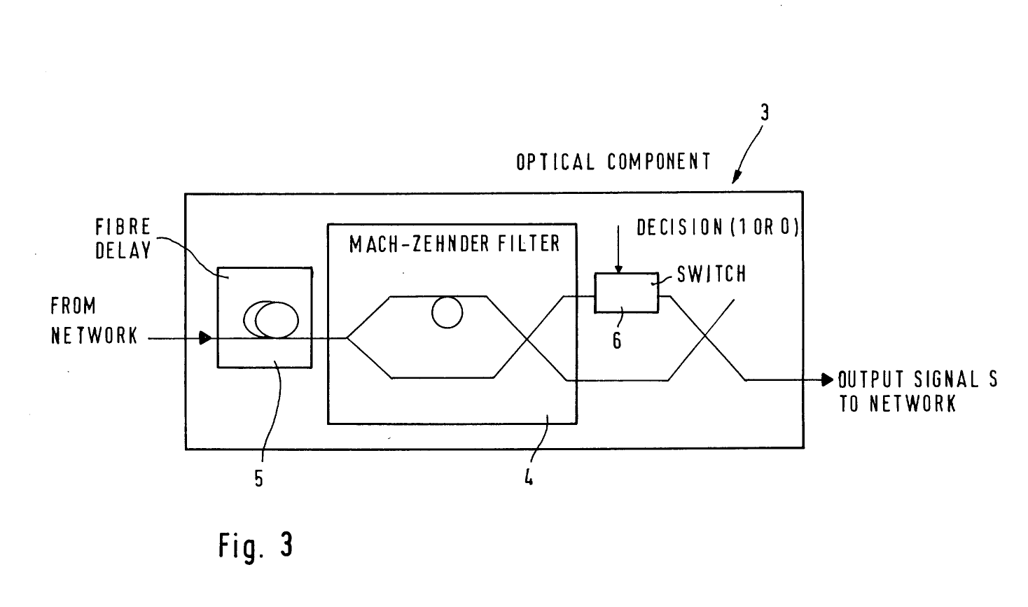

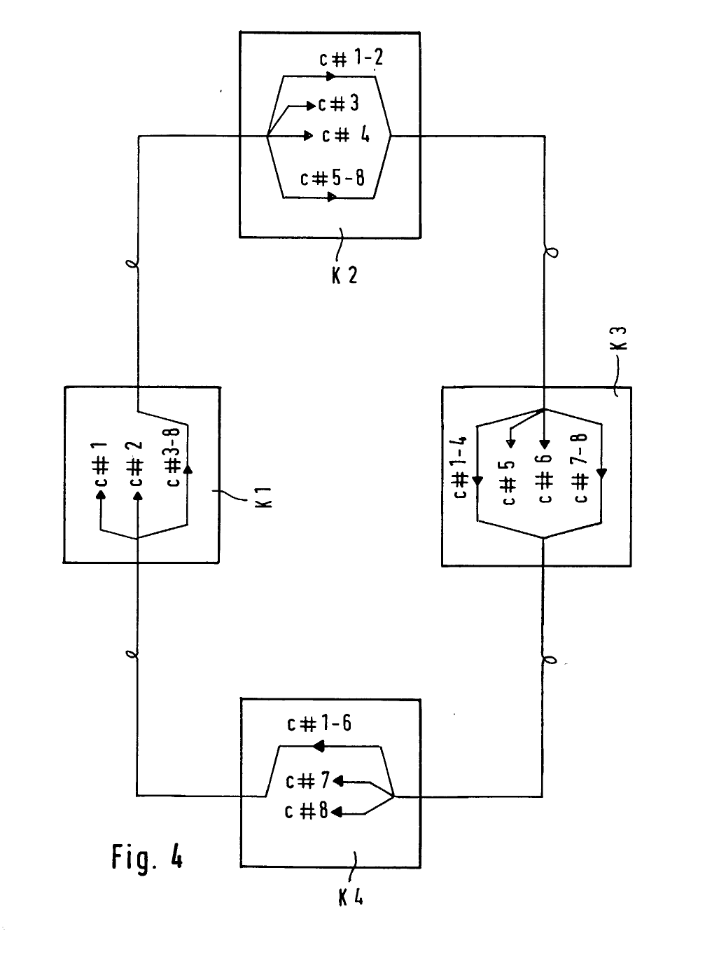

FIG. 3 shows an optical component 3. It contains a filter 4, a time delay element 5 and a switch 6.

The optical component 3 has an input and an output and contains the optical time delay element 5 connected to the input and designed, for example, as a piece of glass fibre. The filter 4 designed, for example, as a Mach-Zehnder filter with two outputs, is connected downstream of the time delay element 5. The Mach-Zehnder filter serves to select the appropriate optical transmission channel.

Switch 6 is controlled by the OCDM detector 2 and connected downstream of an output of the Mach-Zehnder filter.

The output of the optical component 3 is connected via an optical 3 dB coupler to the switch 6 and the other output of the Mach-Zehnder filter.

The time delay element 5 serves to delay the received OCDM signal. The delay is adapted to the processing speed of the OCDM detector 2. The delay is adjusted such that it is matched to the generated control signal for switch 6. If an OCDM signal intended for node 1 is detected in the OCDM detector 2 the switch 6 is controlled in a time-adapted manner such that the corresponding OCDM signal is extinguished and therefore not transmitted.

The OCDM signal is extinguished owing to destructive interference. In the Mach-Zehnder filter the received OCDM signal is transmitted via two paths, undelayed in one path and delayed in the other path, corresponding to a half wavelength or 180° phase displacement. Therefore, there are two OCDM signals displaced by 180° C. available at the outputs of the Mach-Zehnder filter. If these are combined they are extinguished in sum total. If transmission of the one signal is blocked by appropriate control of switch 6 extinguishing does not occur and the OCDM signal is transmitted.

The additional production costs and the space requirement of the optical components 3 are low. Therefore targeted transmission/non-transmission of OCDM signals is achieved in a simple manner on the optical ring. Optical component 3 and OCDM detector 2 can be arranged together on a hybrid integrated circuit, even together with other optoelectronic components. This results in a cost- and space-saving solution. A plurality of OCDM detection devices 1 con also be arranged on a hybrid integrated circuit, for example n, with or without corresponding transmission units.

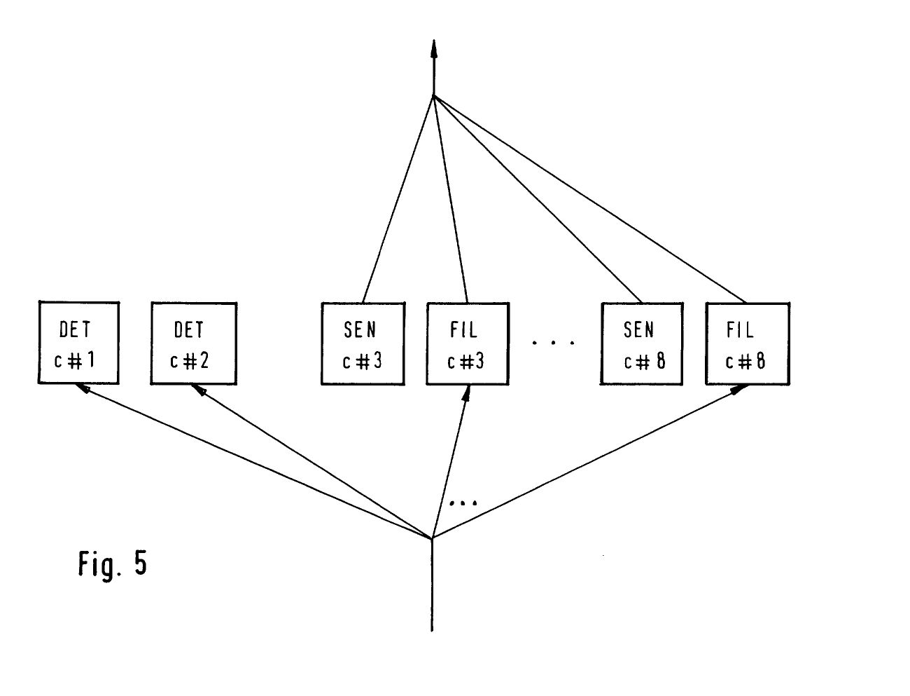

The second embodiment will now be described with the aid of FIG. 4 to 5. FIG. 4 shows an optical ring network. The ring network contains 4 nodes K1, K2, K3, K4 connected to one another via optical lines. The optical lines are formed, for example, by optical glass fibre cables.

OCDM signals are transmitted via the ring network in eight different optical transmission channels c#1, c#2, c#3, c#4, c#5, c#6, c#7, c#8.

The transmission channels c#1, c#2, c#3, c#4, c#5, c#6, c#7, c#8 are allocated to individual nodes K1, K2, K3, K4. Consequently, less complex network management or a less complex MAC protocol is required.

Node K1 receives OCDM signals on the optical transmission channels c#1 and c#2 and transmits OCDM signals on the transmission channels c#3 to c#8 to node K2.

Node K2 receives OCDM signals on the optical transmission channels c#3 and c#4 and transmits OCDM signals on the transmission channels c#1 to c#2 and c#5 to c#8 to node K3.

Node K3 receives OCDM signals on the optical transmission channels c#5 and c#6 and transmits OCDM signals on the transmission channels c#1 to c#4 and c#7 to c#8 to node K4.

Node K4 receives OCDM signals on the optical transmission channels c#7 and c#8 and transmits OCDM signals on the transmission channels c#1 to c#6 to node K1.

FIG. 5 shows by way of example a detail from node K1. Node K1 contains an OCDM detector DET c#1 for detecting OCDM signals on the transmission channel c#1 and an OCDM detector DET c#2 for detecting OCDM signals on the transmission channel c#2.

Node K1 also contains six filters FIL c#3 to FIL c#8 for transmitting OCDM signals on the transmission channels c#3 to c#8, only filter FIL c#3 and filter FIL c#8 being shown schematically in FIG. 5 for the sake of clarity. Each of the six filters FIL c#3 to FIL c#8 contains, for example, an appropriately adapted Mach-Zehnder filter for selecting the appropriate transmission channel. Optionally only four filters FIL c#3 to FIL c#6 can also be used and the two filters c#7 and c#8 dispensed with as the transmission channels C#7 and c#8 are unused on the section K4 to K1.

The inputs of the OCDM detectors DET c#1 and DET c#2 and the inputs of the filters FIL c#3 to FIL c#8 are connected to the glass fibre, connecting the nodes K1 and K4, via an optical splitter.

Node K1 also contains six transmission units SEN c#3 to SEN c#8 for transmitting OCDM signals from node K1 to nodes K2, K3, K4. For the sake of clarity only transmission unit SEN c#3 and SEN c#8 are shown schematically. OCDM signals to be transmitted from node K1 to node K3 are transmitted, for example, via transmission unit SEN c#5 or SEN c#6. Transmission unit SEN c#5 transmits, for example, OCDM signals in the transmission channel c#5, which can be received and detected by node K3.

The outputs of the transmission units SEN c#3 to SEN c#8 and the outputs of the filters FIL c#3 to FIL c#8 are connected to the glass fibre, connecting nodes K1 and K2, via an optical coupler.

In the second embodiment individual transmission channels are received, detected and not transmitted in nodes and the remaining transmission channels not intended for the nodes transmitted via filters. In the example with four nodes a total of eight transmission channels are used, only six transmission channels ever being transmitted simultaneously on one glass fibre. Six transmission channels for transmitting and two transmission channels for receiving OCDM signals are available to each node.

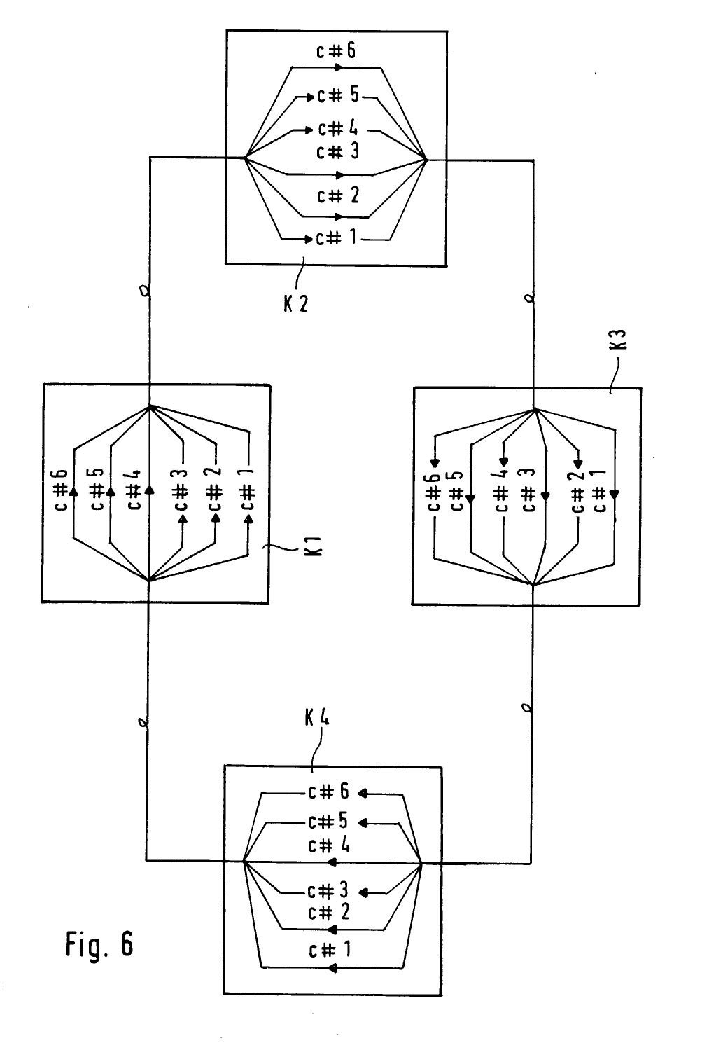

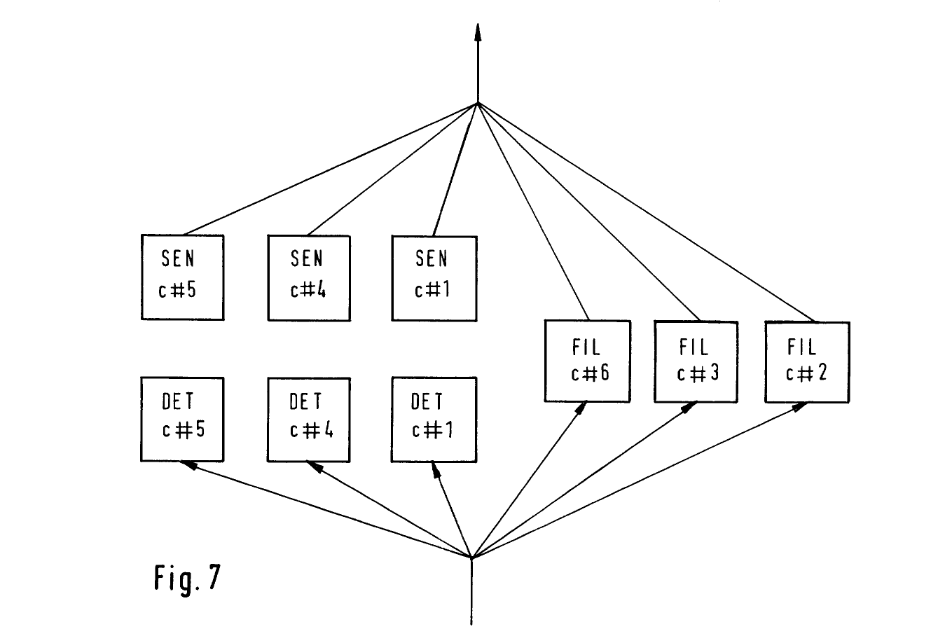

The third embodiment will now be described with the aid of FIG. 6 to 7. FIG. 6 shows an optical ring network. The ring network contains four nodes K1, K2, K3, K4, connected to one another via optical lines. The optical lines are formed, for example, by optical glass fibre cables.

OCDM signals are transmitted in six different optical transmission channels c#1, c#2, c#3, c#4, c#5, c#6 via the ring network.

The transmission channels c#1, c#2, c#3, c#4, c#5, c#6 are allocated to individual nodes K1, K2, K3, K4. Consequently less complex network management or a less complex MAC protocol is required.

Node K1 receives OCDM signals on the optical transmission channels c#1 to c#3 and transmits OCDM signals on the transmission channels c#4 to c#6 to the node K2. Node K1 also transmits new information for node K2 via transmission channel c#1. Node K1 also transmits new information for node K3 via transmission channel c#2. Node K1 also transmits new information for node K4 via transmission channel c#3.

Node K2 receives OCDM signals on the optical transmission channels c#1, c#4, c#5 and transmits OCDM signals on the transmission channels c#2, c#3 and c#6 to the node K3. New information for nodes K1, K3, K4 is also transmitted via the transmission channels c#1, c#4, c#5.

Node K3 receives OCDM signals on the optical transmission channels c#2, c#4, c#6 and transmits OCDM signals on the transmission channels c#1, c#3 and c#5 to node K4. New information for the nodes K1, K2, K4 is also transmitted via the transmission channels c#2, c#4, c#6.

Node K4 receives OCDM signals on the optical transmission channels c#3, c#5 and c#6 and transmits OCDM signals on the transmission channels c#1, c#2 and c#4 to the node K1. New information for the nodes K1, K2, K3 is also transmitted via the transmission channels c#3, c#5, c#6.

The distribution of the transmission channels has the advantage that a total of only six transmission channels are required for four nodes. OCDM signals are transmitted simultaneously in six transmission channels on each transmission section between two nodes, so each transmission section is optimally utilised. Each node has three transmission units and three receiving units for transmitting or receiving OCDM signals to or from three nodes.

FIG. 7 shows by way of example a detail of node K2. Node K2 contains an OCDM detector DET c#1 for detecting OCDM signals on the transmission channel c#1 and an OCDM detector DET c#4 for detecting OCDM signals on the transmission channel c#4 and an OCDM detector DET c#5 for detecting OCDM signals on the transmission channel c#5.

Node K2 also contains three filters FIL c#2, FIL c#3, FIL c#6 for transmitting OCDM signals on the transmission channels c#2, c#3 and c#6. Each of the three filters FIL c#2, FIL c#3, FIL c#6 contains, for example, an appropriately adapted Mach-Zehnder filter for selecting the appropriate transmission channel.

The inputs of the OCDM detectors DET c#1, DET c#4 and DET c#5 and the inputs of the filters FIL c#2, FIL c#3, FIL c#6 are connected to the glass fibre, connecting the nodes K1 and K2, via an optical splitter.

Node K2 also contains three transmission units SEN c#1, SEN c#4 and SEN c#5 for transmitting OCDM signals from node K2 to nodes K1, K3, K4. OCDM signals to be transmitted from node K2 to node K3 are transmitted via transmission unit SEN c#4. Transmission unit SEN c#1 transmits, for example, OCDM signals in the transmission channel c#1, which can be received and detected by node K1.

The outputs of the transmission units SEN c#1, SEN c#4, SEN c#5 and the outputs of the filters FIL c#2, FIL c#3, FIL c#6 are connected to the glass fibre, connecting the nodes K2 and K3, via an optical coupler.

Individual transmission channels are received, detected and also used in nodes for transmitting new information and the remaining transmission channels not intended for the nodes are transmitted via filters in the third embodiment. In the example with four nodes a total of six transmission channels are used, six transmission channels always being simultaneously transmitted on one glass fibre. Three transmission channels for transmitting and three transmission channels for receiving OCDM signals are available to each node.

In the three embodiments optical rings with four or N nodes are used. Instead of four, for example N=100 nodes or N=any random, natural number could be used for each of the embodiments. The number of transmission channels is dependent on the band width of the individual transmission channels and the usable optical band width on the optical glass fibre.

Unidirectional rings are illustrated in the three embodiments. The invention can also be used in bidirectional rings. The bidirectional transmission of OCDM signals via a glass fibre can be used, for example, to increase the transmission capacity on the ring and/or to create replacement paths via which all nodes can still be reached, for example in the case of interference on a glass fibre or failure of a glass fibre, the latter caused, for example, by cable rupture.

In all three embodiments closed optical rings are used. The invention can also be applied in open optical rings, meshed systems or tree structures. The multiple use of an optical transmission channel, on the one hand for receiving OCDM signals and, on the other hand, for transmitting new information, optionally also repeatedly in succession from node to node, is particularly advantageous for this purpose.

1. OCDM detection device containing an OCDM detector for detecting received OCDM signals and an optical component controlled by the OCDM detector for transmission or non-transmission of the received OCDM signals in at least one optical line.

2. OCDM detection device according to claim 1, wherein the optical component has a filter for selecting an optical transmission channel.

3. OCDM detection device according to claim 1, wherein the optical component has an input and an output and contains: an optical time delay element connected to the input, a Mach-Zehnder filter with two outputs connected downstream and a switch connected downstream of an output of the Mach-Zehnder filter and controlled by the OCDM detector, and wherein the output of the optical component is connected to the switch and the other output of the Mach-Zehnder filter.

4. OCDM detection device according to claim 2, wherein the optical time delay element is a piece of glass fibre.

5. OCDM detection device according to claim 1, wherein the OCDM detector serves to detect special OCDM signals in an individual optical transmission channel and is designed in such a way that the optical component is controlled for the transmission of OCDM signals if no special OCDM signals are detected and the optical component is controlled for the non-transmission of OCDM signals if special OCDM signals are detected.

6. OCDM detection device according to claim 1, wherein the input of the optical OCDM detector and the input of the optical component are connected to one another via an optical splitter.

7. Optical network for OCDM containing a plurality of nodes connected to one another via optical lines and each containing at least one OCDM detection device containing an OCDM detector for detecting received OCDM signals and an optical component controlled by the OCDM detector for transmission or non-transmission of the received OCDM signals in at least one optical line.

8. Optical network according to claim 7, wherein each node contains: at least one optical splitter for transmitting the received optical signals via N optical lines, N OCDM detection devices connected in parallel for detection of a respective optical channel and at least one optical combiner for combining the output signals of the N OCDM detection devices, each OCDM detection device containing an OCDM detector for detecting received OCDM signals and an optical component controlled by the OCDM detector for transmission or non-transmission of the received OCDM signals in at least one optical line.

9. Optical network according to claim 8, wherein at least one transmission unit is provided in each node in order to use at least one optical channel for the transmission of information.

10. Nodes for an OCDM system containing one or at least two OCDM detection devices connected in parallel, each OCDM detection device containing an OCDM detector for detecting received OCDM signals and an optical component controlled by the OCDM detector for transmission or non-transmission of the received OCDM signals in at least one optical line.

11. Nodes for an OCDM network containing at least one OCDM detector for detecting received OCDM signals of an individual optical transmission channel and at least one optical component connected in parallel with at least one OCDM detector for the transmission of received OCDM signals of a different individual optical transmission channel.

12. Nodes according to claim 11, wherein at least one transmission unit for transmitting information in an individual optical transmission channel is provided which corresponds to the individual optical transmission channel of one of the at least one OCDM detectors or to the other individual optical transmission channel of one of the at least one optical components.

13. Optical network for OCDM containing a plurality of nodes connected to one another via optical lines, wherein at least one node contains at least one optical component for selecting and transmitting an individual optical transmission channel.
